(19) United States
(12) Patent Application Publication
(10) Pub. No.: US 2013/0310516 A1
(43) Pub. Date: Nov. 21, 2013

(54) CURABLE COMPOSITION AND CURED MATERIAL OF THE SAME

(71) Applicants: Yoshifumi Urakawa, Minato-ku (JP); Shigeru Yamaki, Minato-ku (JP); Nobuaki Ishii, Minato-ku (JP)

(72) Inventors: Yoshifumi Urakawa, Minato-ku (JP); Shigeru Yamaki, Minato-ku (JP); Nobuaki Ishii, Minato-ku (JP)

(73) Assignee: SHOWA DENKO K.K., Minato-ku, Tokyo (JP)

(21) Appl. No.: 13/982,134

(22) PCT Filed: Feb. 17, 2012
(86) PCT No.: PCT/JP2012/053755

§ 371 Date: Jul. 26, 2013

(30) Foreign Application Priority Data
Feb. 25, 2011 (JP) 2011-039828

(51) Int. Cl. C08K 5/5425

(52) U.S. Cl. CPC C08K 5/5425
USPC 524/730

(57) ABSTRACT

The present invention provides a curable composition, wherein a cured material obtainable by curing the curable composition has excellent transparency, thermal durability and surface hardness and has a small Abbe number. In particular, the present invention provides a curable composition containing (a) silica fine particles; (b) a (meth)acrylate compound having two or more ethylenically unsaturated groups; (c) a (meth)allyl compound having two or more ethylenically unsaturated groups and having an aromatic ring structure; and (d) a polymerization initiator; wherein the surface of the silica fine particles (a) has been treated with a specified silane compound (e) and a specified silane compound (f).

### TECHNICAL FIELD

The present invention relates to a specific curable composition and a cured material obtainable by curing the curable composition, which cured material has excellent transparency, thermal durability and surface hardness and has a small Abbe number.

### BACKGROUND ART

With recent developments in technologies in the optical industry, such as optical devices, optical communication and displays, materials excellent in optical properties are demanded. The materials include, for example, optical lenses, optical disk substrates, plastic substrates for liquid crystal display elements, substrates for color filters, plastic substrates for organic EL display elements, substrates for solar cells, touch panels, optical elements, sealing media for optical waveguide and LED, and the like. In particular, strong demands are made on optical properties of optical lenses, optical elements, sealing media for optical waveguide.

In general, inorganic glass is often used as a forming material for substrates for liquid crystal display elements, substrates for color filters, substrates for organic EL display elements, substrates for solar cells and touch panels, etc. However, many attempts have been made in recent years to use plastic materials instead of glass plates, since glass plates have problems: they are fragile; they cannot be bended; they are not suitable for weight reduction because of the specific gravity thereof; and the like. Furthermore, since light passes through the above-described optical materials, for example, substrates for liquid crystal display elements, high transparency is required. Moreover, these optical materials are often mounted outermost in final products and, when exposed to the air or touched by a man or others, can be damaged, thus requiring excellent surface hardness.

As a forming material for optical lenses, optical elements, and sealing media for optical waveguide and LED, such plastic materials excellent in thermal durability as those having reflow resistance have been demanded in recent years.

In more recent years, research is extensively carried out so as to provide clear pictures by achieving high resolution and high pixel. In optical materials such as optical lenses, responding to this trend is required, and therefore, it is essentially important to reduce the chromatic aberration of the optical materials. It is known to be effective in reduction of chromatic aberration to combine a material(s) having a large Abbe number (Abbe number around about 45 to 65) with a material(s) having a small Abbe number (Abbe number around about 25 to 45) (see, for example, p193 in “Practical polymer materials seen by their characteristics” by Fumio Ide, issued in 2002 by Industrial Research Association).

As a conventionally used forming material for optical materials, for example, JP-A No. 10-77321 (Patent Literature 1) discloses a component prepared by curing a resin composition with active energy rays, wherein the resin composition comprises an amorphous thermoplastic resin and a bis(meth)acrylate, which is curable with active energy rays. Furthermore, the Patent Literature 1 describes that, instead of glass substrate, the component is preferably utilized for optical lenses, optical disk substrates and plastic substrates for liquid crystal display, etc. However, the transparency of the component can be reduced because of the difference in refractive index between the amorphous thermoplastic resin and the resin obtained by curing the bis(meth)acrylate with active energy rays.

A curable composition is disclosed in JP-A No. 10-298252 (Patent Literature 2), wherein a silica-based condensation polymer, which has been obtained by hydrolysis and condensation polymerization of a specific silane compound in a disperse system of a colloidal silica, is dispersed uniformly in a radical-polymerizable vinyl compound such as methyl methacrylate, or in a bisphenol A-type ethylene oxide-modified (meth)acrylate. Furthermore, the Patent Literature 2 describes that the composition can provide a cured material excellent in transparency and hardness and that the cured material is useful in applications such as an optical material. However, the thermal durability of the cured material is not examined in the Patent Literature.

Furthermore, an example of the plastic materials conventionally used for optical lenses is polycarbonate. JP-A No. 2003-90901 (Patent Literature 3) discloses a polycarbonate copolymer resin, which is derived from a dihydroxy compound component containing cyclohexanedimethanol and a specific bisphenol at a certain ratio, as well as plastic lenses, optical disk substrates, light diffusion plates and light-guiding plates or the like, which are produced from a blend of the polycarbonate resin. The plastic material obtainable by the invention disclosed in this Patent Literature has solved the objects such as achieving high transparency, high resistance to impact and excellent balance between Abbe number and refractive index (an Abbe number of 31 to 48). However, the plastic material has insufficient thermal durability.

Furthermore, JP-A No. 2002-97217 (Patent Literature 4) describes a composition having excellent handling properties in production process, in terms of balance in refractive index, fluidity and the like, wherein the excellent handling properties are brought by the combination of a sulfur-containing (meth)acrylate compound with a certain amount of a polymerization inhibitor and a polymerization initiator, and describes an optical material derived from the composition, which have such physical properties in molded articles after curing as high refractive index and high transparency. However, the Patent Literature does not describe specifically the transparency of the cured material obtained by curing the composition and does not discuss the thermal durability of the cured material, while it discusses the transparency of the composition itself. Furthermore, since the cured material contains sulfur, the material can be easily colored or degraded by heat, and thus the transparency can be impaired.

### CITATION LIST

### Patent Literatures

Patent Literature 1: JP-A No. 10-77321
Patent Literature 2: JP-A No. 10-298252
Patent Literature 3: JP-A No. 2003-90901
Patent Literature 4: JP-A No. 2002-97217

### SUMMARY OF INVENTION

### Technical Problem

As described above, at present, a material having excellent transparency and thermal durability and having a small Abbe number has not developed.

The present invention was made in such a situation, and the object to be solved by the present invention is to provide a curable composition, wherein a cured material obtainable by curing the curable composition has excellent transparency, thermal durability and surface hardness and has a small Abbe number.

### Technical Solution

The inventors extensively studied to achieve the above-described object and discovered a curable composition to solve the above-described object, the curable composition comprising (a) silica fine particles whose surface has been treated with specified silane compounds, (b) a (meth)acrylate compound(s) having two or more ethylenically unsaturated groups, (c) a (meth)allyl compound(s) having two or more ethylenically unsaturated groups and having an aromatic ring structure, and (d) a polymerization initiator(s). Here, (meth)acrylate compound means acrylate and/or methacrylate. Furthermore, (meth)allyl means allyl and/or methallyl. Hereinafter, other (meth)acrylate compounds and (meth)allyl compounds have the same meanings.

The present invention specifically relates to the following items.

[1] A curable composition comprising:

(a) silica fine particles;

(b) a (meth)acrylate compound having two or more ethylenically unsaturated groups;

(c) a (meth) allyl compound having two or more ethylenically unsaturated groups and having an aromatic ring structure; and

(d) a polymerization initiator;

wherein the surface of the silica fine particles (a) is treated with a silane compound (e) represented by the general formula (1) below and a silane compound (f) represented by the general formula (2) below:

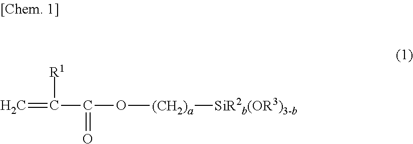

(wherein in formula (1), R¹ represents a hydrogen atom or a methyl group; R² represents an alkyl group having 1 to 3 carbon atoms or a phenyl group; R³ represents a hydrogen atom or a hydrocarbon group having 1 to 10 carbon atoms; a is an integer of 1 to 6; b is an integer of 0 to 2; when b is 0 or 1, the plural R³s may be the same or different; and when b is 2, the two R²s may be the same or different);

[Chem. 2]

X—(CH₂)_{c}—SiR⁴_{d}(OR⁵)_{3-d} (2)

(wherein in formula (2), X represents an aromatic group having 6 to 12 carbon atoms; R⁴ represents an alkyl group having 1 to 3 carbon atoms or a phenyl group; R⁵ represents a hydrogen atom or a hydrocarbon group having 1 to 12 carbon atoms; c is an integer of 0 to 6; d is an integer of 0 to 2; when d is 0 or 1, the plural R⁵s may be the same or different; and when d is 2, the two R⁴s may be the same or different).
[2] The curable composition according to [1], wherein the (meth)allyl compound (c) is(are) represented by the general formula (3) below:

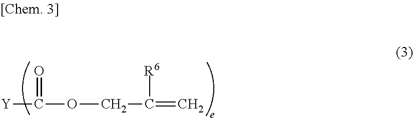

(wherein in formula (3), e is an integer of 2 to 4; R⁶ represents a hydrogen atom or a methyl group; the plural R⁶s may be the same or different; and Y represents an organic residue having 6 to 18 carbon atoms and having an aromatic ring structure).
[3] The curable composition according to [1] or [2], wherein in the general formula (1) R¹ represents a methyl group; R² represents a methyl group; R³ represents a methyl group or an ethyl group; a is 2 or 3; and b is 0 or 1.
[4] The curable composition according to any one of [1] to [3], wherein in the general formula (2) R⁴ represents a methyl group; R⁵ represents a methyl group or an ethyl group; c is 0 or 1; and d is 0 or 1.
[5] The curable composition according to any one of [1] to [4], wherein the (meth)acrylate compound (b) is a (meth)acrylate compound having three or more ethylenically unsaturated groups and having no ring structure.
[6] The curable composition according to any one of [1] to [4], wherein the (meth)acrylate compound (b) is a (meth)acrylate compound having two ethylenically unsaturated groups and having a fluorene structure.
[7] The curable composition according to any one of [1] to [6], the surface of the silica fine particles (a) is treated with 5 to 95 parts by mass of the silane compound (e) per 100 parts by mass of the silica fine particles (a) and with 5 to 95 parts by mass of the silane compound (f) per 100 parts by mass of the silica fine particles (a).
[8] The curable composition according to any one of [1] to [7], wherein a homopolymer of the (meth)acrylate compound (b) has (have) a glass transition temperature not less than 80° C.
[9] The curable composition according to any one of [1] to [8], comprising 5 to 200 parts by mass of the (meth) allyl compound (c) per 100 parts by mass of the silica fine particles (a), whose surface has not been treated.
[10] The curable composition according to any one of [1] to [9], comprising 20 to 500 parts by mass of the (meth)acrylate compound (b) per 100 parts by mass of the silica fine particles (a), whose surface has not been treated.
[11] The curable composition according to any one of [1] to [10], comprising 0.01 to 10% by mass of the polymerization initiator (d) per 100% by mass of the curable composition.
[12] A cured material obtainable by curing the curable composition according to any one of [1] to [11].
[13] The cured material according to [12], wherein the Abbe number of the cured material is not more than 50.
[14] An optical material composed of the cured material according to [12] or [13].
[15] An optical lens composed of the cured material according to [12] or [13].

### Advantageous Effects of Invention

According to the present invention, provided are a curable composition, wherein a cured material having excellent transparency, thermal durability and surface hardness and having a small Abbe number can be produced by curing the curable composition; and a cured material obtainable by curing the curable composition.

### DESCRIPTION OF EMBODIMENTS

The following describes the embodiments of the present invention in detail. The scope of the present invention shall not be limited to the specific aspects of the implementation described below.

### [Curable Composition]

The curable composition of the present invention comprises (a) silica fine particles whose surface has been treated with specified silane compounds (e) and (f), (b) a (meth)acrylate compound(s) having two or more ethylenically unsaturated groups (hereinafter simply referred to as “reactive (meth)acrylate (b)”), (c) a (meth)allyl compound(s) having two or more ethylenically unsaturated groups and having an aromatic ring structure (hereinafter simply referred to as “reactive (meth)allyl (c)”), and (d) a polymerization initiator(s). Each of the components will be described below.

<Silica Fine Particles (a)>

Silica fine particles (a) are used to improve the thermal durability and environmental durability of a cured material obtainable by curing a thermally curable composition of the present invention.

As the silica fine particle (a) used in the present invention, particles having an average particle diameter of 1 to 100 nm are preferably used. When the average diameter is less than 1 nm, the curable composition of the present invention increases the viscosity, the content of the silica fine particles (a) in the curable composition is limited, and the dispersibility of the particle (a) in the curable composition is deteriorated, and thus the cured material tends to fail to gain sufficient transparency and thermal durability. Furthermore, when the average diameter is more than 100 nm, the transparency of the cured material may be deteriorated.

In terms of the balance between the viscosity and the transparency of the curable composition, the average particle diameter of the silica fine particles (a) is more preferably from 1 to 50 nm, still more preferably from 5 to 50 nm, and most preferably from 5 to 40 nm. Additionally, silica fine particles are observed using a high-resolution transmission electron microscope (Model H-9000 manufactured by Hitachi, Ltd.) and any 100 silica particle images are selected from the observed fine particle images, and thereby the average particle diameter of the silica fine particles (a) is obtained as a number average particle diameter through a known statistical method for image processing.

In the present invention, silica fine particles, whose average diameters are different from each other, may be used in combination, thereby increasing the filler content of the silica fine particle (a) in the cured material of the present invention. Furthermore, as the silica fine particles (a), porous silica sol or a complex metallic oxide of silicon with aluminum, magnesium, zinc or the like may be used.

The content of the silica fine particles (a) in the curable composition of the present invention is preferably 5 to 80% by mass, and more preferably 5 to 60% by mass in terms of balance between the thermal durability of the cured material and the viscosity of the curable composition. When the content is within this range, the fluidity of the curable composition and the dispersibility of the silica fine particles (a) in the curable composition would be excellent, and thus, using such a curable composition, a cured material having sufficient hardness and thermal durability could be produced. Additionally, as described below, silica fine particles dispersed in an organic solvent may be used as the silica fine particles (a). In this case, the content of the silica fine particles (a) refers to the mass of only the silica fine particles dispersed in the organic solvent.

As the silica fine particles (a), from the point of the dispersibility thereof in the curable composition, silica fine particles dispersed in an organic solvent is preferably used. As the organic solvent, an organic solvent, which dissolves organic components contained in the curable composition (the reactive (meth)acrylate(s) (b) and the reactive (meth)allyl(s) (c) described below), is preferably used.

Examples of the organic solvent include, for example, alcohols, ketones, esters and glycol ethers. Alcoholic organic solvents, such as methanol, ethanol, isopropyl alcohol, butyl alcohol, n-propyl alcohol or the like, and ketonic organic solvents, such as methyl ethyl ketone, methyl isobutyl ketone or the like, are preferred, because the organic solvents are easily removed from a mixture of the silica fine particles (a), the reactive (meth)acrylate(s) (b) and the reactive (meth)allyl(s) (c) in a solvent-removing step of the manufacturing process, as described below, for the curable composition of the present invention.

Among those, isopropyl alcohol is particularly preferred. In cases where silica fine particles (a) dispersed in isopropyl alcohol are used, the viscosity of the curable composition after removal of the solvent is lower relative to the cases where other solvents are used, and therefore the curable composition having a low viscosity and having excellent handling properties can be stably produced.

Such silica fine particles dispersed in an organic solvent can be produced using a commonly known method, or are commercially available as a product having a trade name of Snowteck IPA-ST (manufactured by Nissan Chemical Industries, Ltd.) and the like. Other silica fine particles described above can be produced using a commonly known method and are also commercially available.

Furthermore, the surface of the silica fine particles (a) is treated with the silane compound(s) (e) and the silane compound(s) (f). Each of these silane compounds will be described below.

<Silane Compound (e)>

The viscosity of the curable composition can be reduced by treating the surface of the silica fine particles (a) with a silane compound(s) (e). Moreover, the silane compound(s) (e) attached to the silica fine particles (a) (the chemical structure thereof has been changed) reacts with the reactive (meth)acrylate(s) (b) and the reactive (meth)allyl(s) (c) described below, thereby improving the dispersion stability of the silica fine particles (a) in the curable composition.

Accordingly, the silane compound(s) (e) is(are) used to reduce hardening shrinkage at curing the curable composition and to impart fabrication and processing properties. That is, in cases where silica fine particles (a) are not treated with the silane compound(s) (e), the viscosity of the curable composition increases as well as the hardening shrinkage at curing the composition becomes larger, the cured material becomes fragile, and cracks are formed in the cured material, and thus it is undesired.

The silane compound (e) is a compound represented by the general formula (1) below:

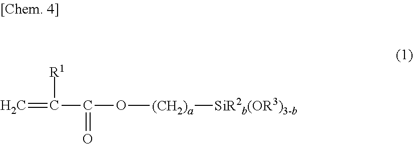

In the formula (1), R¹ represents a hydrogen atom or a methyl group; R² represents an alkyl group having 1 to 3 carbon atoms or a phenyl group; R³ represents a hydrogen atom or a hydrocarbon group having 1 to 10 carbon atoms; a is an integer of 1 to 6; and b is an integer of 0 to 2. Additionally, in cases where b is 2, the two R²s may be the same or different; and in cases where b is 0 or 1, the plural R^{a}s may be the same or different.

Examples of the hydrocarbon group having 1 to 10 carbon atoms include, for example, methyl group, ethyl group and isopropyl group, etc.

Furthermore, a substituent(s) such as, for example, methyl group, methoxy group and chloro group can be bound to the phenyl group so long as it does not impair the effect of the present invention.

Among those, in terms of reduction in the viscosity and the stability during storage of the curable composition of the present invention, a silane compound represented by the general formula (1), in which R¹ represents a methyl group, R² represents a methyl group, R³ represents a methyl or ethyl group, a is 2 or 3, and b is 0 or 1, is preferred; and a silane compound represented by the general formula (1), in which R¹ represents a methyl group, R³ represents a methyl group, a is 3, and b is 0, is more preferred; as the silane compound(s) (e).

Specific examples of the silane compound (e) include, for example, γ-acryloxypropyldimethylmethoxysilane, γ-acryloxypropylmethyldimethoxysilane, γ-acryloxypropyldiethylmethoxysilane, γ-acryloxypropylethyldimethoxysilane, γ-acryloxypropyltrimethoxysilane, γ-acryloxypropyldimethylethoxysilane, γ-acryloxypropylmethyldiethoxysilane, γ-acryloxypropyldiethylethoxysilane, γ-acryloxypropylethyldiethoxysilane, γ-acryloxypropyltriethoxysilane, γ-methacryloxypropyldimethylmethoxysilane, γ-methacryloxypropylmethyldimethoxysilane, γ-methacryloxypropyldiethylmethoxysilane, γ-methacryloxypropylethyldimethoxysilane, γ-methacryloxypropyltrimethoxysilane, γ-methacryloxypropyldimethylethoxysilane, γ-methacryloxypropylmethyldiethoxysilane, γ-methacryloxypropyldiethylethoxysilane, γ-methacryloxypropylethyldiethoxysilane and γ-methacryloxypropyltriethoxysilane, etc.

In terms of prevention of aggregation of the silica fine particles (a) in the curable composition, reduction of the viscosity and improvement of the stability during storage of the curable composition, as the silane compound (e), γ-acryloxypropyldimethylmethoxysilane, γ-acryloxypropylmethyldimethoxysilane, γ-methacryloxypropyldimethylmethoxysilane, γ-methacryloxypropylmethyldimethoxysilane, γ-acryloxypropyltrimethoxysilane and γ-methacryloxypropyltrimethoxysilane are preferred; and γ-methacryloxypropyltrimethoxysilane and γ-acryloxypropyltrimethoxysilane are more preferred.

In cases where an acrylate (the reactive acrylate (b) described below) is contained abundantly in the curable composition of the present invention, a silane compound having an acrylic group, that is, a silane compound represented by the general formula (1), in which R¹ is a hydrogen atom, is preferably used as the silane compound (e); and in cases where a methacrylate (the reactive methacrylate (b) described below) is contained abundantly in the curable composition, a silane compound having a methacrylic group, that is, a silane compound represented by the general formula (1), in which compound R¹ is a methyl group, is preferably used as the silane compound (e). In such cases, when the curable composition of the present invention is cured, the curing reaction easily occurs.

One kind of the above-described silane compounds (e) may be used alone or two or more kinds of the compounds may be used in combination.

Furthermore, such silane compounds (e) can beproducedusing a commonly known method(s), or are commercially available.

<Silane Compound (f)>

The surface treatment of the silica fine particles (a) with the silane compound(s) (f) allows the silica fine particles (a) to react with the silane compound(s) (f), thereby imparting hydrophobic properties to the surface of the silica fine particles (a). Moreover, it improves the dispersibility of the silica fine particles (a) in the curable composition as well as the compatibility of the silica fine particles (a) with the reactive (meth)acrylate(s) (b) and reactive (meth)allyl(s) (c) described below, and thereby it can reduce the viscosity of the curable composition of the present invention and can improve the stability of the curable composition during storage in addition.

The silane compound (f) used in the present invention is a compound represented by the general formula (2) below:

[Chem. 5]

X—(CH₂)_{c}—SiR⁴_{d}(OR⁵)_{3-d} (2).

In the formula (2), X represents an aromatic group having 6 to 12 carbon atoms; R⁴ represents an alkyl group having 1 to 3 carbon atoms or a phenyl group; R⁵ represents a hydrogen atom or a hydrocarbon group having 1 to 12 carbon atoms; c is an integer of 0 to 6; d is an integer of 0 to 2. Additionally, in cases where d is 2, the two R⁴s may be the same or different; and in cases where d is 0 or 1, the plural R⁵s may be the same or different. Furthermore, a substituent(s) such as, for example, methyl group, methoxy group and chloro group can be bound to the phenyl group so long as it does not impair the effect of the present invention.

Examples of the aromatic group having 6 to 12 carbon atoms include, for example, phenyl group, biphenyl group and naphthyl group, etc. A substituent(s) such as, for example, methyl group, methoxy group and chloro group can be bound to these so long as it does not impair the effect of the present invention.

Examples of the hydrocarbon group having 1 to 12 carbon atoms include not only linear hydrocarbon groups such as alkyl groups but also cyclic hydrocarbon groups and aromatic hydrocarbon groups. Examples of such hydrocarbon groups include, for example, methyl group, ethyl group, isopropyl group, phenyl group and biphenyl group, etc. A substituent(s) such as, for example, methyl group, methoxy group and chloro group can be bound to these phenyl group and biphenyl group so long as it does not impair the effect of the present invention.

In terms of reduction in the viscosity and the stability during storage of the curable composition of the present invention, a silane compound represented by the general formula (2), in which X represents a phenyl group, R⁴ represents a methyl group, R⁵ represents a methyl or ethyl group, c is 0 or 1, and d is 0 or 1, is preferred; a silane compound represented by the general formula (2), in which X represents a phenyl group, R⁵ represents a methyl group, c is 0 or 1, and d is 0, is more preferred; and a silane compound represented by the general formula (2), in which X represents a phenyl group, R⁵ represents a methyl group, c is 0, and d is 0, is particularly preferred; as the silane compound (f).

Examples of the silane compound (f) include, for example, phenyldimethylmethoxysilane, phenylmethyldimethoxysilane, phenyldiethylmethoxysilane, phenylethyldimethoxysilane, phenyltrimethoxysilane, phenyldimethylethoxysilane, phenylmethyldiethoxysilane, phenyldiethylethoxysilane, phenylethyldiethoxysilane, phenyltriethoxysilane, benzyldimethylmethoxysilane, benzylmethyldimethoxysilane, benzyldiethylmethoxysilane, benzylethyldimethoxysilane, benzyltrimethoxysilane, benzyldimethylethoxysilane, benzylmethyldiethoxysilane, benzyldiethylethoxysilane, benzylethyldiethoxysilane, benzyltriethoxysilane, and diphenyldimethoxysilane, etc.

In terms of reduction of the viscosity and improvement of the stability during storage of the curable composition of the present invention, phenyldimethylmethoxysilane, phenylmethyldimethoxysilane, phenyldiethylmethoxysilane, phenylethyldimethoxysilane, phenyltrimethoxysilane and diphenyldimethoxysilane are preferred; and phenyltrimethoxysilane and diphenyldimethoxysilane are more preferred.

One kind of the above-described silane compounds (f) may be used alone or two or more kinds of the compounds may be used in combination.

Such silane compounds (f) can be produced using a commonly known method(s), or are commercially available.

### <Used Amounts of the Silane Compound(s) (e) and the Silane Compound(s) (f) in the Surface Treatment>

The surface of the silica fine particles (a) is treated with the above-described silane compounds (e) and (f), and the used amount of the silane compounds to 100 parts by mass of the silica fine particles (a) is, in the silane compound(s) (e), typically 5 to 95 parts by mass, preferably 5 to 50 parts by mass, and more preferably 10 to 30 parts by mass; and it is, in the silane compound(s) (f), typically 5 to 95 parts by mass, preferably 5 to 50 parts by mass, and more preferably 10 to 30 parts by mass. Additionally, in cases where silica fine particles (a) dispersed in an organic solvent are used, the mass of the silica fine particles (a) refers to the mass of only the silica fine particles dispersed in the organic solvent.

When the used amount of the silane compound(s) (e) or (f) is less than 5 parts by mass, the viscosity of the curable composition of the present invention is increased, the dispersibility of the silica fine particles (a) is reduced in the curable composition, and thus gelation can occur in the curable composition, and the thermal durability of a cured material obtained from the curable composition can be decreased. On the other hand, when the used amount of the silane compound(s) (e) or (f) is more than 95 parts by mass, it can cause the silica fine particles (a) to aggregate in the curable composition.

When the total used amount of the silane compounds (e) and (f) is more than 190 parts by mass per 100 parts by mass of the silica fine particles (a), because the amount of those processing agents is abundant, a reaction can occur among silica fine particles during the surface treatment of the silica fine particle (a), and therefore aggregation and gelation can occur in the curable composition.

### <(Meth)Acrylate Compound (b) Having Two or More Ethylenically Unsaturated Groups>

The curable composition of the present invention contains a (meth)acrylate compound(s) (b) having two or more ethylenically unsaturated groups. The component(s) contribute(s) to the excellent thermal durability of a cured material obtainable by curing the curable composition.

The reactive (meth)acrylate (b) used in the present invention is not particularly limited, so long as it has two or more ethylenically unsaturated groups and (meth)acrylate structures. Additionally, the ethylenically unsaturated group may be overlapped with the (meth)acrylate structure. That is, for example, a compound, which has two (meth)acrylate structures within the molecule and no unsaturated bond on the part of the molecule other than the (meth)acrylate structures, shall have two ethylenically unsaturated groups and (meth)acrylate structures.

As the reactive (meth)acrylate (b) like this, a (meth)acrylate compound having three or more ethylenically unsaturated groups and having no ring structure is preferred in terms of increase in thermal durability; and a (meth)acrylate compound having two ethylenically unsaturated groups and having a fluorene structure is preferred in terms of reduction in the Abbe number.

Examples of the former compound include, for example, trimethylolpropane tri(meth)acrylate, pentaerythritol tri(meth)acrylate, pentaerythritol tetra(meth)acrylate, dipentaerythritol tetra(meth)acrylate, dipentaerythritol penta(meth)acrylate, dipentaerythritol hexa(meth)acrylate and trimethylolpropane trioxyethyl(meth)acrylate, etc.

Examples of the latter compound include, for example, 9,9-bis[4-((meth)acryloyloxy)phenyl]fluorene, 9,9-bis[4-(2-(meth)acryloyloxyethoxy)phenyl]fluorene, 9,9-bis[4-(2-(meth)acryloyloxyethoxyethoxy)phenyl]fluorene, and those having trade names OGSOL EA-0200, EA-1000, EA-F5003 and EA-F5503 manufactured by Osaka Gas Chemicals Co., Ltd., etc.

Additionally, the number of ethylenically unsaturated groups is typically not more than 6 in the reactive (meth)acrylate(s) (b) used in the present invention.

In terms of increase in the thermal durability of a cured material obtained from the curable composition, the glass transition temperature of homopolymers of the reactive (meth)acrylates (b) (a polymer composed of a repeat unit of the (meth)acrylate compound (b) structure; in cases where, for example, 3 or more ethylenically unsaturated groups are contained in the (meth)acrylate compound (b), the polymer can have a branching point(s)) is preferably not less than 80° C., and more preferably not less than 200° C. Specifically, for example, a homopolymer of trimethylolpropane tri(meth)acrylate has a glass transition temperature not less than 200° C. Additionally, the glass transition temperature of the homopolymer is typically not more than 300° C.

Among those multifunctional (meth)acrylates, trimethylolpropane tri (meth)acrylate is most preferred, because, with the acrylate, hardening shrinkage is relatively small in the curable composition of the present invention, and a homopolymer of the acrylate has a high glass transition temperature so that the thermal durability is excellent in a cured material obtained from the curable composition.

Additionally, the glass transition temperature of a homopolymer is measured by the method below.

One part by mass of diphenyl(2,4,6-trimethylbenzoyl) phosphine oxide (Trade Name: Lucirin TPO-L, manufactured by BASF Japan Ltd.) as a photoinitiator is dissolved in 100 parts by mass of the reactive (meth)acrylate compound(s) (b), the resulting mixture is applied on a glass substrate (50 mm×50 mm) such that the thickness of a cured film will be 200 μm, and a coating film is exposed to light at an intensity of 4 J/cm² using an exposure device equipped with an extra-high pressure mercury lamp, thereby producing a cured film. Using the cured film, a glass transition temperature is determined from the temperature giving the maximum of tan δ values measured with DMS 6100 (manufactured by Seiko Instruments & Electronics Ltd.) at tensile mode in a temperature range from 30 to 300° C. at a heating rate of 2° C./min at a frequency of 1 Hz.

The amount of the reactive acrylate(s) (b) to be combined in the curable composition of the present invention is preferably 20 to 500 parts by mass, from the points of the viscosity of the curable composition, the dispersion stability of the silica fine particles (a) in the curable composition and the thermal durability of the cured material, more preferably 30 to 300 parts by mass, and still more preferably 50 to 200 parts by mass, per 100 parts by mass of the silica fine particles (a), whose surface has not been treated. When the amount to be combined is less than 20 parts by mass, the viscosity of the curable composition is increased and therefore gelation can occur. On the other hand, when the amount to be combined is more than 500 parts by mass, shrinkage at the time of curing becomes larger in the curable composition, and it can cause bending and cracking in the cured material. Additionally, in cases where silica fine particles (a) dispersed in an organic solvent are used, the mass of the silica fine particles (a) refers to the mass of only the silica fine particles dispersed in the organic solvent.

### <(Meth)Allyl Compound (c) Having Two or More Ethylenically Unsaturated Groups and an Aromatic Ring Structure>

The reactive (meth)allyl (c) used in the present invention is a compound having two or more ethylenically unsaturated groups and an aromatic ring structure, and by containing the reactive (meth)allyl(s) (c) in the curable composition of the present invention, the Abbe number of a cured material obtained from the composition can be reduced. Accordingly, optical materials with a small chromatic aberration can be provided by combining the cured material of the present invention and a material(s) with a large Abbe number.

Furthermore, (meth) allyl refers to the 2-propenyl structure or the 2-methyl-2-propenyl structure. Additionally, the number of ethylenically unsaturated groups is typically not more than 6 in the reactive (meth) allyl(s) (c) used in the present invention.

As the reactive (meth)allyl (c), for example, a compound represented by the general formula (3) below can be used:

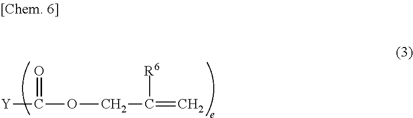

In the formula (3), e is an integer of 2 to 4; R⁶ represents a hydrogen atom or a methyl group; the plural R⁶s may be the same or different; and Y represents an organic residue having 6 to 18 carbon atoms and having an aromatic ring structure. Such reactive (meth)allyls (c) having carbonyl structures and having an aromatic ring structure is preferred, because it can decrease the Abbe number of the cured material of the present invention.

Additionally, aromatic ring refers to an unsaturated cyclic structure, in which atoms with pi electrons are arranged to form a ring. The above-described “6 to 18 carbon atoms” means that the number of carbon atoms, including those of an aromatic ring, is from 6 to 18.

In the above-described general formula (3), in order to increase the curing rate of the curable composition of the present invention and the reaction rate of the ethylenically unsaturated groups, R⁶ preferably represents a hydrogen atom.

In the above-described general formula (3), in terms of increase in the thermal durability of a cured material obtained from the curable composition and the ready availability of synthetic material(s) for the reactive (meth)allyl(s) (c) (particularly a synthetic material providing the structure Y in the general formula (3)), e is preferably 2 or 3, and more preferably 2.

In the above-described general formula (3), in terms of reduction in the Abbe number of the cured material and the viscosity of the curable composition of the present invention, the number of carbon atoms in Y is preferably 6 to 12, and more preferably 6 to 10.

Specific examples of Y can include those represented by (h) to (p) below:

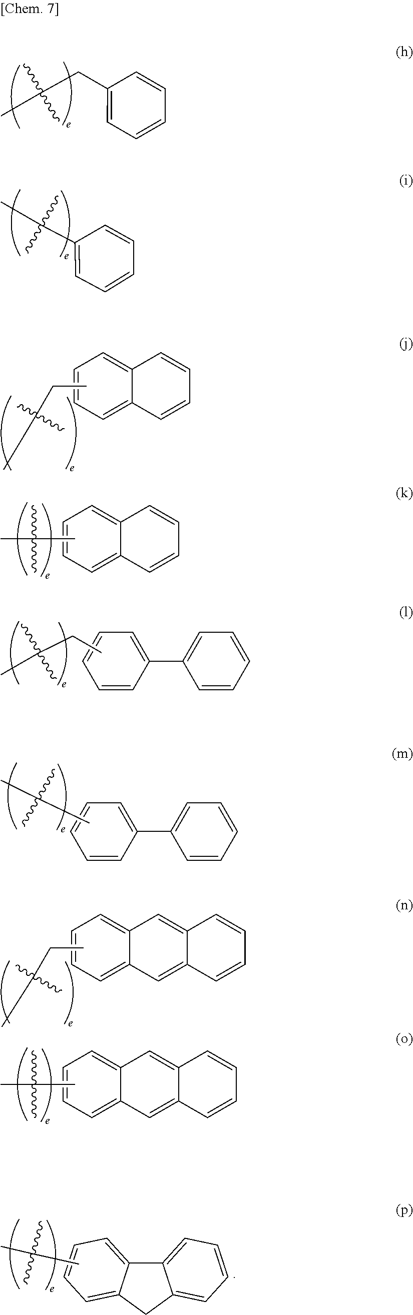

Additionally, in the structural formulas described above, apart with a wavy line denotes the binding arm of Y in the compounds represented by the general formula (3).

Among those specific examples described above, in terms of the Abbe number of the cured material, the viscosity and the ready availability of the curable composition, those having a naphthoyl backbone of (k) and those having a biphenyl backbone of (1) are preferred.

That is, an aromatic group-containing (meth)allyl compound represented by the general formula (4) below and an aromatic group-containing (meth)allyl compound represented by the general formula (6) described below are particularly preferred as the reactive (meth)allyl (c):

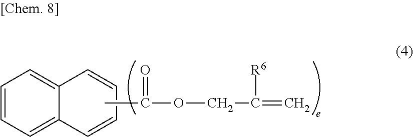

In the above-described general formula (4), e is an integer of 2 to 4, R⁶ represents a hydrogen atom or a methyl group, and the plural R⁶s may be the same or different.

In the above-described general formula (4), R⁶ preferably represents a hydrogen atom in order to increase the curing rate of the curable composition of the present invention and the reaction rate of the ethylenically unsaturated groups.

In the above-described general formula (4), in terms of increase in the thermal durability of a cured material obtained from the curable composition and in terms of the ready availability of compounds having a naphthoyl backbone, e is preferably 2 or 3, and more preferably 2.

Moreover, in the above-described general formula (4), in terms of the handling properties and the ready availability of compounds having a naphthoyl backbone, carbonyl groups are more preferably attached at the 1,4-positions, 2,3-positions, 2,6-positions or 2,7-positions of a naphthalene, and still more preferably attached at the 2,3-positions.

That is, a compound having a structure represented below is particularly preferred:

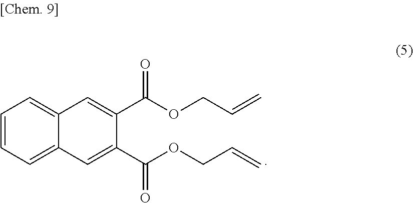 [SMILES: C=CCOC(=O)c1cc2ccccc2cc1C(=O)OCC=C]

Furthermore, as described above, an aromatic group-containing (meth)allyl compound represented by the general formula (6) below, wherein Y in the general formula (3) is a compound having a biphenyl backbone, is also preferred as the reactive (meth)allyl (c):

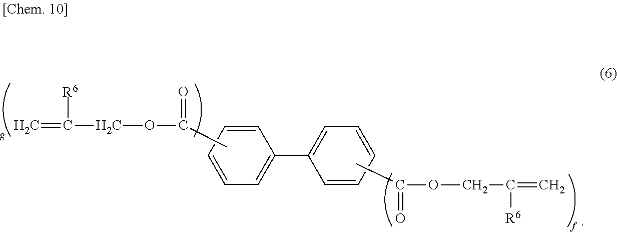

In the above-described general formula (6), R⁶ represents a hydrogen atom or a methyl group, f and g are each independently integer of 0 to 2, and the sum of f and g is 2 or more. In cases where f and g are 2, the two R⁶s on each ring may be the same or different.

In the above-described general formula (6), R⁶ preferably represents a hydrogen atom in order to increase the curing rate of the curable composition of the present invention and the reaction rate of the ethylenically unsaturated groups.

In the above-described general formula (6), f and g are more preferably 0 or 1 in terms of increase in the thermal durability of a cured material obtained from the curable composition of the present invention and in terms of the ready availability of compounds having a biphenyl backbone. Additionally, the sum of f and g is 2 or more as described above.

Moreover, in the above-described general formula (6), carbonyl groups are more preferably attached at the 2,2′-positions or 4,4′-positions of a diphenyl in terms of the ready availability of compounds having a biphenyl backbone, and still more preferably attached in the 2,2′-positions.

That is, a compound having a structure represented below is particularly preferred:

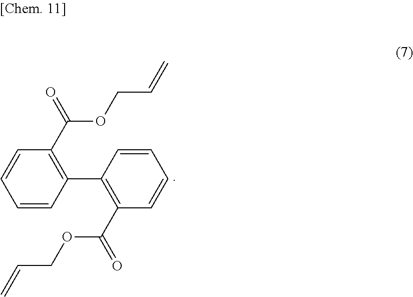 [SMILES: C=CCOC(=O)c1ccccc1-c1ccccc1C(=O)OCC=C]

As the reactive (meth)allyl (c), those represented by the above-described general formula (4) and the above-described general formula (6) as well as other various compounds can be used. Examples of such a compound include, for example, o-diallylbenzene, m-diallylbenzene, p-diallylbenzene, diallyl phthalate, diallyl isophthalate, diallyl terephthalate and 1,8-anthracenedicarboxylic acid diallyl ester, etc.

One kind of the above-described reactive (meth)allyls (c) may be used alone or two or more kinds of the compounds may be used in combination.

Among the exemplary (meth)allyl compounds described above, in order to achieve reduction in the Abbe number of a cured material obtained from the curable composition of the present invention and in terms of the thermal durability of the cured material, the (meth)allyl compound represented by the above-described general formula (4) and the (meth)allyl compound represented by the above-described general formula (6) are preferred.

As the reactive (meth)allyl (c), a compound represented by the general formula (8) below also can be used:

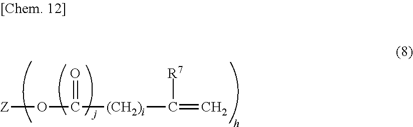

In the general formula (8), R⁷ represents a hydrogen atom or a methyl group. Furthermore, h is an integer of 2 to 4; i is an integer of 1 to 5; and j is 0 or 1. Z represents an organic residue having 6 to 18 carbon atoms and having an aromatic ring structure. The definition of the aromatic ring structure is as described above.

In the above-described general formula (8), in order to increase the curing rate of the curable composition of the present invention and the reaction rate of the ethylenically unsaturated groups, R⁷ preferably represents a hydrogen atom.

In the above-described general formula (8), from the points of increase in the thermal durability of an obtainable cured material and the ready availability of synthetic material(s) for the reactive (meth)allyl(s) (c), h is preferably 2 or 3, and more preferably 2.

In the above-described general formula (8), from the point of increase in the thermal durability and refractive index of an obtainable cured material, i is preferably an integer of 1 to 3, and more preferably 1 or 2.

In the above-described general formula (8), in terms of reduction of the Abbe number and the viscosity of the curable composition of the present invention, the number of carbon atoms in Z is preferably 6 to 14, and more preferably 6 to 10.

Specific examples of Z include those represented by (h′) to (p′) below:

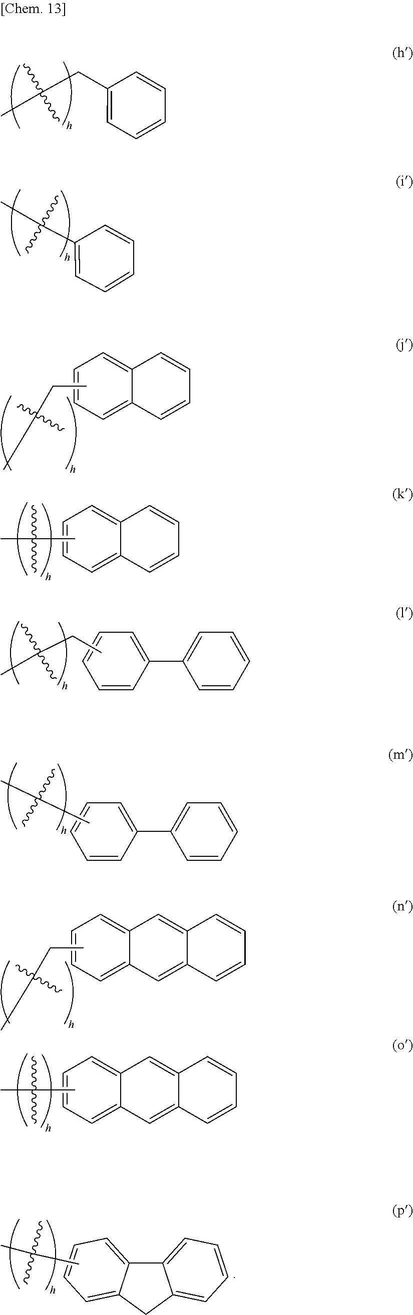

Additionally, in the structural formulas described above, a part with a wavy line denotes the binding arm of Z in the compounds represented by the general formula (8).

Among those specific examples described above, in terms of Abbe number, viscosity and ready availability of raw materials, those having a naphthoyl backbone of (j′) or (k′), and those having a biphenyl backbone of (l′) or (m′) are preferred.

In compounds having a naphthoyl backbone of (j′) or (k′), from the points of the handling properties and ready availability of raw materials, the structure inside the parentheses with a subscript of “h” in the general formula (8) is more preferably attached at the 1,4-positions, 2,3-positions 2,6-positions, or 2,7-positions of a naphthalene.

In compounds having a biphenyl backbone of (1′) or (m′), in terms of the ready availability of raw materials, the structure inside the parentheses with a subscript of “h” in the general formula (8) is more preferably attached at the 2,2′-positions or 4,4′-positions of a biphenyl.

One kind of the above-described reactive (meth)allyls (c) may be used alone or two or more kinds of the compounds may be used in combination.

In terms of the thermal durability of a cured material obtainable by curing the curable composition of the present invention, a (meth)allyl compound is preferred as the reactive (meth)allyl (c), wherein a homopolymer of the (meth)allyl compound (a polymer composed of a repeat unit of the (meth)allyl compound (c) structure; in cases where, for example, 3 or more ethylenically unsaturated groups are contained in the (meth)allyl compound (c), the polymer can have a branching point(s)) has a glass transition temperature not less than 80° C. The method for measuring the glass transition temperature of a homopolymer is the same as that described above. Additionally, the glass transition temperature of a homopolymer will be typically not more than 300° C.

The amount of the reactive allyl(s) (c) to be combined in the curable composition of the present invention is preferably 5 to 200 parts by mass, in terms of the viscosity of the curable composition, the dispersion stability of the silica fine particles (a) in the curable composition, increase in the thermal durability of a cured material, and decrease in the Abbe number of a cured material, more preferably 10 to 150 parts by mass, and still more preferably 10 to 100 parts by mass, per 100 parts by mass of the silica fine particles (a), whose surface has not been treated. When the amount to be combined is less than 5 parts by mass, the Abbe number cannot be sufficiently decreased. On the other hand, when the amount to be combined is more than 200 parts by mass, a cured material obtained from the curable composition can be colored and curing can be insufficient.

<Polymerization Initiator (d)>

Examples of the polymerization initiator (d) include, for example, photoinitiators and thermal initiators, which generate radicals.

Examples of the photoinitiator include, for example, benzophenone, benzoin methyl ether, benzoin propyl ether, diethoxyacetophenone, 1-hydroxy-phenyl-phenyl-ketone, (2,6-dimethylbenzoyl)diphenylphosphine oxide, (2,4,6-trimethylbenzoyl)diphenylphosphine oxide and diphenyl (2,4,6-trimethylbenzoyl) phosphine oxide. For these photoinitiators, one kind of these may be used alone or two or more kinds of these may be used in combination.

The content of the photoinitiator(s) in the curable composition of the present invention is only that required for curing moderately the curable composition and it is preferably 0.01 to 10% by mass, more preferably 0.02 to 5% by mass, and still more preferably 0.1 to 2% by mass, per 100% by mass of the curable composition. When the content of the photoinitiator(s) is too high, the stability of the curable composition during storage can be reduced, the curable composition can be colored, or a cross-linking reaction can proceed rapidly in the course of cross-linking to obtain a cured material so that problems such as cracking can occur at the time of curing. Furthermore, when the content of the photoinitiator(s) is too low, the curable composition cannot be sufficiently cured.

Examples of the thermal initiator include benzoyl peroxide, diisopropyl peroxycarbonate, t-butyl peroxy(2-ethylhexanoate), t-butyl peroxyneodecanoate, t-hexyl peroxypivalate, 1,1,3,3-tetramethylbutyl peroxy-2-ethylhexanoate, t-butyl peroxypivalate, t-butyl peroxy-2-ethylhexanoate, t-hexyl peroxy isopropyl monocarbonate, dilauroyl peroxide, diisopropyl peroxydicarbonate, di(4-t-butylcyclohexyl)peroxydicarbonate, 2,2-di(4,4-di(t-butylperoxy)cyclohexyl)propane and the like.

The content of the thermal initiator in the curable composition of the present invention is only that required for curing moderately the curable composition and it is preferably 0.01 to 10% by mass, more preferably 0.02 to 5% by mass, and still more preferably 0.1 to 2% by mass, per 100% by mass of the curable composition.

The curable composition of the present invention comprising the above-described components (a) to (d) contains the silica fine particles (a) whose surface has been treated with the specified silane compounds, and therefore the viscosity thereof is low and the handling properties thereof in the form of composition are excellent;

the curable components (b) and (c) are used together with the polymerization initiator(s) and they are rigidly cured in a polymerization reaction, and thus a cured material excellent in thermal durability and surface hardness is obtained, whose transparency is equal to or higher than those of conventional products;

hardening shrinkage in the composition is restrained during the curing of the composition due to the presence of the surface-treated silica fine particles (a), and it results in decreased bending of the cured material (frequently formed as a film on a substrate) and prevents the cured material from becoming fragile and cracking; and furthermore,

a small Abbe number can be achieved in the cured material due to the reactive (meth)allyl(s) (c) in the composition.

Optical materials with a small chromatic aberration, which possess properties such as transparency, thermal durability and surface hardness, can be provided by combining such a cured material and a material(s) with a large Abbe number. The curable composition of the present invention described in the foregoing can contain other components, such as those described below, in addition to the above-described necessary components (a) to (d).

### <Other Components>

The curable composition of the present invention can contain, as necessary, a polymerization inhibitor(s), a leveling agent(s), an antioxidant(s), an ultraviolet absorbing agent(s), a light stabilizer(s), a pigment(s), a filler(s) such as other inorganic fillers, a reactive diluent(s) or a modifying agent(s) and the like, so long as it does not impair properties such as the viscosity of the composition and the transparency and thermal durability of the cured material.

The polymerization inhibitor is used to prevent the components of the curable composition from polymerizing during storage. Examples of the polymerization inhibitor include, for example, hydroquinone, hydroquinone monomethyl ether, benzoquinone, p-t-butylcatechol and 2,6-di-t-butyl-4-methylphenol, etc.

The amount of the polymerization inhibitor(s) to be added is preferably not more than 0.1 parts by mass per 100 parts by mass of the curable composition in terms of the transparency of the composition and the thermal durability of the cured material. For the polymerization inhibitors, one kind of these may be used alone or two or more kinds of these may be used in combination.

Examples of the leveling agent include, for example, polyether-modified dimethylpolysiloxane copolymer, polyester-modified dimethylpolysiloxane copolymer, polyether-modified methylalkylpolysiloxane copolymer, aralkyl-modified methylalkylpolysiloxane copolymer and polyether-modified methylalkylpolysiloxane copolymer, etc. For the leveling agents, one kind of these may be used alone or two or more kinds of these may be used in combination.

The antioxidant is a compound having the function to capture an oxidation promoting factor(s) such as free radicals.

The antioxidant is not particularly limited so long as it is a commonly used antioxidant in industry, and phenol-based antioxidants, phosphorus-based antioxidant and sulfur-based antioxidant or the like can be used. For the antioxidants, one kind of these may be used alone or two or more kinds of these may be used in combination.

Examples of the phenol-based antioxidants include, for example, Irganox 1010 (pentaerythritol tetrakis[3-(3,5-di-t-butyl-4-hydroxyphenyl)propionate], manufactured by BASF Japan Ltd.), Irganox 1076 (octadecyl-3-(3,5-di-t-butyl-4-hydroxyphenyl)propionate, manufactured by BASF Japan Ltd.), Irganox 1330 (3,3′,3″, 5,5′,5″-hexa-t-butyl-a,a′,a″-(mesitylene-2,4,6-triyl)tri-p-cresol, manufactured by BASF Japan Ltd.), Irganox 3114 (1,3,5-tris(3,5-di-t-butyl-4-hydroxybenzyl)-1,3,5-triazine-2,4,6(1H,3H,5H)-trione, manufactured by BASF Japan Ltd.), Irganox 3790 (1,3,5-tris((4-t-butyl-3-hydroxy-2,6-xylyl)methyl)-1,3,5-triazine-2,4,6(1H,3H,5H)-trione, manufactured by BASF Japan Ltd.), Irganox 1035 (thiodiethylene bis[3-(3,5-di-t-butyl-4-hydroxyphenyl)propionate], manufactured by BASF Japan Ltd.), Irganox 1135 (benzenepropanoic acid, 3,5-bis(1,1-dimethylethyl)-4-hydroxy, C7-C9 branched alkyl esters, manufactured by BASF Japan Ltd.), Irganox 1520L (4,6-bis(octylthiomethyl)-o-cresol, manufactured by BASF Japan Ltd.), Irganox 3125 (manufactured by BASF Japan Ltd.), Irganox 565 (2,4-bis(n-ocrylthio)-6-(4-hydroxy-3′,5′-di-t-butylanilino)-1, 3,5-triazine, manufactured by BASF Japan Ltd.), ADK Stab AO-80 (3,9-bis(2-(3-(3-t-butyl-4-hydroxy-5-methylphenyl)propionyloxy)-1,1-dimethylethyl)-2,4,8,10-tetraoxaspiro(5,5)undecane, manufactured by ADEKA Corporation), Sumilizer BHT (manufactured by Sumitomo Chemical Co., Ltd.), Sumilizer GA-80 (manufactured by Sumitomo Chemical Co., Ltd.), Sumilizer GS (manufactured by Sumitomo Chemical Co., Ltd.), Cyanox 1790 (manufactured by Cytec Industries Inc.) and vitamin E (manufactured by Eisai Co., Ltd.), etc.

Examples of the phosphorus-based antioxidants include, for example, Irgafos 168 (tris(2,4-di-t-butylphenyl)phosphite, manufactured by BASF Japan Ltd.), Irgafos 12 (tris[2-[[2,4,8,10-tetra-t-butyldibenzo[d,f][1,3,2]dioxaphosphin-6-yl]oxy]ethyl]amine, manufactured by BASF Japan Ltd.), Irgafos 38 (bis(2,4-bis(1,1-dimethylethyl)-6-methylphenyl)ethyl phosphite, manufactured by BASF Japan Ltd.), ADK Stab 329K (manufactured by ADEKA Corporation), ADK Stab PEP36 (manufactured by ADEKA Corporation), ADK Stab PEP-8 (manufactured by ADEKA Corporation), Sandstab P-EPQ (manufactured by Clariant International Ltd.), Weston 618 (manufactured by General Electric Company), Weston 619G (manufactured by General Electric Company), Ultranox 626 (manufactured by General Electric Company) and Sumilizer GP (6-[3-(3-t-butyl-4-hydroxy-5-methylphenyl)propoxy]-2,4,8,10-tetra-t-butyldibenz[d,f][1.3.2]dioxaphosphepin, manufactured by Sumitomo Chemical Co., Ltd.), etc.

Examples of the sulfur-based antioxidants include, for example, dilauryl thiodipropionate, dialkyl thiodipropionate compounds such as dimyristyl thiodipropionate and distearyl thiodipropionate, and β-alkylmercaptopropionate compounds such as tetrakis[methylene (3-dodecylthio) propionate] methane, etc.

The above-described ultraviolet absorbing agent is a compound, which can generally absorb ultraviolet rays in a range from about 200 to 380 nm in wavelength and transform them into other types of energy such as heat and infrared rays and emit the energy.

The ultraviolet absorbing agent is not particularly limited so long as it is a commonly used ultraviolet absorbing agent in industry, and, benzotriazole-based, triazine-based, diphenylmethane-based, 2-cyanopropenoate-based, salicylate-based, anthranilate-based, cinnamic acid derivative-based, camphor derivative-based, resolcinol-based, oxalinide-based and coumarin derivative-based ultraviolet absorbing agents or the like can be used in the present invention. For the ultraviolet absorbing agents, one kind of these may be used alone or two or more kinds of these may be used in combination.

Examples of the benzotriazole-based ultraviolet absorbing agents include, for example,
2,2-methylenebis[4-(1,1,3,3-tetramethylbutyl)-6 [(2H-benzotriazol-2-yl)phenol]],
2-(2H-benzotriazol-2-yl)-4-(1,1,3,3-tetramethylbutyl)phenol
and
2-[5-chloro (2H)-benzotriazol-2-yl]-4-methyl-6-(t-butyl)phenol, etc.

Examples of the triazine-based ultraviolet absorbing agents include, for example,
2-(4,6-diphenyl-1,3,5-triazin-2-yl)-5-[(hexyl) oxy]-phenol,
2,4,6-tris-(diisobutyl 4′-amino-benzalmalonate)-s-triazine,
4,6-tris(2-hydroxy-4-octyloxyphenyl)-1,3,5-triazine,
2-(2-hydroxy-4-octyloxyphenyl)-4,6-bis(2,4-dimethylphenyl)-1,3,5-triazine,
2-(2,4-dihydroxyphenyl)-4,6-bis(2,4-dimethylphenyl)-1,3,5-triazine,
2,4-bis(2-hydroxy-4-propyloxyphenyl)-6-(2,4-dimethylphenyl)-1,3,5-triazine and
2-(2-hydroxy-4-dodecyloxyphenyl)-4,6-bis(2,4-dimethylphenyl)-1,3,5-triazine, etc.

Examples of the diphenylmethane-based ultraviolet absorbing agents include, for example, diphenylmethanone, methyldiphenylmethanone, 4-hydroxy diphenylmethanone, 4-methoxy diphenylmethanone, 4-octoxy diphenylmethanone, 4-decyloxy diphenylmethanone, 4-dodecyloxy diphenylmethanone, 4-benzyloxy diphenylmethanone, 4,2′,4′-trihydroxy diphenylmethanone, 2′-hydroxy-4,4′-dimethoxy diphenylmethanone, 4-(2-ethylhexyloxy)-2-hydroxy-diphenylmethanone and methyl o-benzoyl benzoate and benzoin ethyl ether, etc.

Examples of the 2-cyanopropenoate-based ultraviolet absorbing agents include, for example, ethyl α-cyano-β,β-diphenyl propenoate and isooctyl α-cyano-β,β-diphenyl propenoate, etc.

Examples of the salicylate-based ultraviolet absorbing agents include, for example, isocetyl salicylate, octyl salicylate, glycol salicylate and phenyl salicylate, etc.

Examples of the anthranilate-based ultraviolet absorbing agents include, for example, menthyl anthranilate, etc.

Examples of the cinnamic acid derivative-based ultraviolet absorbing agents include, for example, ethylhexyl methoxycinnamate, isopropyl methoxycinnamate, isoamyl methoxycinnamate, diisopropyl methylcinnamate, glyceryl ethyl hexanoate dimethoxycinnamate, methyl α-carbomethoxycinnamate and methyl α-cyano-β-methyl-p-methoxy cinnamate, etc.

Examples of the camphor derivative-based ultraviolet absorbing agents include, for example, benzylidene camphor, benzylidene camphor sulfonic acid, camphor benzalkonium methosulfate, terephthalylidene dicamphor sulfonic acid and polyacrylamide methylbenzylidene camphor, etc.

Examples of the resolcinol-based ultraviolet absorbing agents include, for example, dibenzoylresorcinol bis(4-t-butylbenzoylresorcinol), etc.

Examples of the oxalinide-based ultraviolet absorbing agents include, for example, 4,4′-di-octyloxy oxanilide, 2,2′-diethoxyoxy oxanilide, 2,2′-di-octyloxy-5,5′-di-t-butyl oxanilide, 2,2′-di-dodecyloxy-5,5′-di-t-butyl oxanilide, 2-ethoxy-2′-ethyl oxanilide, N,N′-bis(3-dimethylaminopropyl) oxanilide and 2-ethoxy-5-t-butyl-2′-ethoxy oxanilide, etc.

Examples of the coumarine-based ultraviolet absorbing agents include, for example, 7-hydroxycoumarine, etc.

The light stabilizer is a compound, which has an effect to suppress deterioration of cured materials by reducing autoxidative degradation by radicals, which have been generated through light energy.

The light stabilizer is not particularly limited so long as it is a commonly used light stabilizer in industry, and hindered amine-based compounds (hereinafter referred to as “HALS”), benzophenone-based compounds, benzotriazole-based compounds and the like can be used. For these light stabilizers, one kind of these may be used alone or two or more kinds of these may be used in combination.

Examples of the HALSs include, for example, high molecular weight HALSs, wherein a plural number of piperidine rings are linked through a triazine backbone, such as N,N′,N″,N″′-tetrakis(4,6-bis(butyl(N-methyl-2,2,6,6-tetramethylpiperidin-4-yl)amino)triazin-2-yl)-4,7-diazadecane-1,10-diamine, a polycondensate of dibutylamine, 1,3,5-triazine and N,N′-bis(2,2,6,6-tetramethyl-4-piperidyl)butylamine, poly[{(1,1,3,3-tetramethylbutyl)amino-1,3,5-triazin-2,4-diyl} {(2,2,6,6-tetramethyl-4-piperidyl)imino}hexamethylene{(2,2,6, 6-tetramethyl-4-piperidyl)imino}], a polycondensate of 1,6-hexanediamine-N,N′-bis(2,2,6,6-tetramethyl-4-piperidyl) and morphorine-2,4,6-trichloro-1,3,5-triazine, poly[(6-morphorino-s-triazin-2,4-diyl)[(2,2,6,6,-tetramethyl-4-piperidyl)imino]-hexamethylene[(2,2,6,6-tetramethyl-4-piperidyl)imino], and the like; high molecular weight HALSs, wherein piperidine rings are linked by an ester bond, such as a polymer of dimethyl succinate and 4-hydroxy-2,2,6,6-tetramethyl-1-piperidine ethanol, and an esterification mixture of 1,2,3,4-butanetetracarboxylic acid, 1,2,2,6,6-pentamethyl-4-piperidinol and 3,9-bis(2-hydroxy-1,1-dimethylethyl)-2,4,8,10-tetraoxaspiro[5,5]undecane; and pentamethylpiperidinyl methacrylate, etc.

Examples of the above-described fillers and pigments include, for example, calcium carbonate, talc, mica, clay, Aerosil® or the like, barium sulfate, aluminum hydroxide, zinc stearate, zinc oxide, red iron oxide and azo pigments, etc.

### <Viscosity of the Curable Composition>

The curable composition of the present invention contains each kind of component as described above and the viscosity of the composition at 25° C. measured using a Type-B rheometer DV-III ULTRA (manufactured by Brookfield Engineering Laboratories Inc.) is typically 30 to 10,000 mPa·s, and preferably 100 to 8,000 mPa·s. The curable composition of the present invention has an appropriate viscosity and excellent handling properties, even if it does not contain a solvent. This is due to the high reactivity and compatibility of the silica fine particles (a) with the reactive (meth)acrylate(s) (b) and the reactive (meth)allyl(s) (c), which are caused by the above-described surface treatment of the silica fine particles (a), and to the high dispersion stability of the silica fine particles (a) in the reactive (meth)acrylate(s) (b) and the reactive (meth)allyl(s) (c).

### <Production Process of the Curable Composition>

The curable composition of the present invention can be produced by performing the following steps sequentially: (step 1) subjecting silica particles (a) dispersed, for example, in an organic solvent to a surface treatment with the silane compounds (e) and (f); (step 2) adding the reactive (meth)acrylate(s) (b) and the reactive (meth)allyl(s) (c) to the surface-treated silica fine particles (a) and mixing them uniformly; (step 3) distilling the uniform mixture of the silica fine particles (a), the reactive (meth)acrylate(s) (b) and the reactive (meth)allyl(s) (c) obtained in the step 2 to remove water and the organic solvent; (step 4) adding the polymerization initiator(s) (d) to the composition distilled for solvent removal in the step 3 and mixing them uniformly to obtain the curable composition. Each step will be described below.

### (Step 1)

In the step 1, the surface of the silica fine particles (a) is treated with the silane compounds (e) and (f).

The surface treatment is carried out as follows: the silica fine particles (a) are added to a reactor and then the silane compounds (e) and (f) are added with stirring, and they are mixed by stirring; water and a catalyst(s), which are required for hydrolysis of the silane compounds, are added and the hydrolytic polycondensation of the silane compounds on the surface of the silica fine particles (a) is carried out with stirring. Additionally, as described in the foregoing, silica fine particles dispersed in an organic solvent is preferably used as the silica fine particle (a).

In the course of the hydrolysis, the loss of the silane compounds by hydrolysis can be confirmed by gas chromatography. The loss of the silane compounds by hydrolysis can be confirmed, because the remaining amounts of the silane compounds can be measured by the internal standard method with gas chromatography (Model 6850; manufactured by Agilent Technologies Inc.) using a non-polar column DB-1 (manufactured by J&W Scientific) at a temperature from 50 to 300° C. at a heating rate of 10° C./min and using He as a carrier gas at a flow rate of 1.2 cc/min and a hydrogen flame ionization detector.

As described in the foregoing, the amount of the silane compound(s) (e) to be used in the surface treatment of the silica fine particles (a) is typically 5 to 95 parts by mass, preferably 5 to 50 parts by mass, and more preferably 10 to 30 parts by mass, per 100 parts by mass of the silica fine particles (a). Furthermore, the amount of the silane compound(s) (f) to be used is typically 5 to 95 parts by mass, preferably 5 to 50 parts by mass, and preferably 10 to 30 parts by mass, per 100 parts by mass of the silica fine particles (a).

The amount of water required for hydrolysis is typically 1 to 100 parts by mass, preferably 1 to 50 parts by mass, and more preferably 1 to 30 parts by mass, per 100 parts by mass of the silica fine particles (a). When the amount of water is excessively small, hydrolysis rate is extremely decreased, and therefore it can result in uneconomical production, insufficient progress in the surface treatment, and the like. When the amount of water is excessively large, on the contrary, the silica fine particles (a) can form a gel. Additionally, in cases where silica fine particles (a) dispersed in an organic solvent are used, the mass of the silica fine particles (a) refers to the mass of only the silica fine particles dispersed in the organic solvent.

When hydrolysis is carried out, a catalyst for a hydrolysis reaction is typically used. Specific examples of such a catalyst include, for example,

inorganic acids such as hydrochloric acid, acetic acid, sulfuric acid and phosphoric acid;
organic acids such as formic acid, propionic acid, oxalic acid, p-toluenesulfonic acid, benzoic acid, phthalic acid and maleic acid;
alkaline catalysts such as potassium hydroxide, sodium hydroxide, calcium hydroxide and ammonia;
organometals;
metal alkoxides; organotin compounds such as dibutyltin dilaurate, dibutyltin dioctyrate and dibutyltin diacetate;
metal chelating compounds such as aluminum tris (acetylacetonate), titanium tetrakis(acetylacetonate), titanium bis(butoxy)bis(acetylacetonate), titanium bis(isopropoxy)bis(acetylacetonate), zirconium bis(butoxy)bis(acetylacetonate) and zirconium bis(isopropoxy)bis(acetylacetonate) or the like; and boron compounds such as boron butoxide and boric acid.

Among those, hydrochloric acid, acetic acid, maleic acid and boron compounds are preferred because of their water solubility and ability to catalyze hydrolysis at a sufficient rate. For these catalysts, one kind of these may be used alone or two or more kinds of the compounds may be used in combination.

When the hydrolysis of the silane compounds (e) and (f) is carried out in the step 1, a non-water soluble catalyst(s) can be used, but a water soluble catalyst(s) is (are) preferably used. In cases where a water soluble catalyst(s) for the hydrolytic reaction is(are) used, the water soluble catalyst(s) is(are) dissolved in an appropriate amount of water and then added to the reaction system, and thus the catalyst(s) can preferably be dispersed uniformly.

The amount of a catalyst(s) for hydrolysis to be added is not particularly limited, and it is typically 0.01 to 1 part by mass, and preferably 0.01 to 0.5 parts by mass, per 100 parts by mass of the silica particle (a). Additionally, in cases where silica fine particles dispersed in an organic solvent are used as the silica fine particles (a), the mass of the silica fine particles (a) refers to the mass of only the silica fine particles dispersed in the organic solvent. Furthermore, in the present invention, the catalysts can be used as an aqueous solution, in which each of the catalysts is dissolved in water, and, in that case, the amount of the catalyst to be added represents only the amount of the catalysts.

The reaction temperature of the hydrolytic reaction is not particularly limited, and it is typically within a range from 10 to 80° C., and preferably within a range from 20 to 50° C. The reaction temperature which is excessively low and hydrolysis rate which is extremely decreased can result in uneconomical production, insufficient progress in the surface treatment, and the like. When the reaction temperature is excessively high, a gelation reaction tends to easily occur.

Furthermore, the reaction time of the hydrolytic reaction is not particularly limited, and it is typically within a range from 10 min to 48 hours, and preferably within a range from 30 min to 24 hours.

Additionally, at the step 1, both surface treatments with the silane compound(s) (e) and the silane compound(s) (f) can be carried out sequentially, but a simultaneous treatment in one step is preferred in respect of simplification and optimization of the reaction process.

### (Step 2)

In the step 2, the method for mixing the surface-treated silica fine particles (a), the reactive (meth)acrylate(s) (b) and the (meth)allyl(s) (c) is not particularly limited, and examples of the method include, for example, a method in which they are mixed at room temperature or under heating conditions by a mixing device such as mixer, ball mill or triple roll mill, and a method in which the reactive (meth)acrylate(s) (b) and the (meth)allyl(s) (c) are added and mixed with continuous stirring in the reactor, with which the step 1 has been carried out.

### (Step 3)

In the step 3, to distil and remove (hereinafter these are together referred to as “remove”) organic solvent and water from the uniform mixture of the silica fine particles (a), the reactive (meth)acrylate(s) (b) and the (meth)allyl(s) (c), the step is carried out by heating the mixture under reduced pressure.

Temperature is maintained preferably at 20 to 100° C., in terms of the balance between the prevention of aggregation and gelation and the solvent removal rate, more preferably at 30 to 70° C., and still more preferably at 30 to 50° C. When temperature is too high, it can result in the extremely low fluidity and in gelation of the curable composition.

When the pressure is reduced, the degree of vacuum is typically 10 to 4,000 kPa, in terms of the balance between the prevention of aggregation and gelation and the solvent removal rate, more preferably 10 to 1,000 kPa, and most preferably 10 to 500 kPa. When the degree of pressure is too high, it can result in the extremely slow solvent removal rate and uneconomical production.

Preferably, the composition after solvent removal substantially contains no solvent. As used herein, “substantially” means that, when a cured material is obtained from the curable composition of the present invention, as a practical matter, the composition is not required to undergo another step of solvent removal; and it specifically means that the remaining amount of organic solvent and water in the curable composition is preferably not more than 1% by mass, more preferably not more than 0.5% by mass, and still more preferably not more than 0.1% by mass.

In the step 3, a polymerization inhibitor can be added to 100 parts by mass of the composition after solvent removal, such that the added amount will be not more than 0.1 parts by mass. A polymerization inhibitor can be used to prevent the components of the composition from polymerizing during removal of solvent and during storage of the curable composition and composition thereof after the removal of solvent.

The step 3 can be carried out using a special apparatus, to which a uniform mixture of the silica fine particles (a), the reactive (meth)acrylate(s) (b) and the reactive (meth)allyl(s) (c) that have undergone the step 2 are transferred, or, in cases where the step 2 has been carried out using the reactor with which the step 1 had been carried out, the step 3, which follows the step 2, can be carried out in the same reactor.

### (Step 4)

In the step 4, the method of adding the polymerization initiator(s) (d) to the solvent-removed composition of the step 3 and mixing them uniformly is not particularly limited, and examples of the method include, for example, a method in which they are mixed at room temperature by a mixing device such as mixer, ball mill or triple roll mill, and a method in which the polymerization initiator(s) (d) is(are) added and mixed with continuous stirring in the reactor, with which the steps 1 to 3 have been carried out.

Moreover, the curable composition obtained by performing such addition and mixture of the polymerization initiator(s) (d) can be filtrated as necessary. The aim of this filtration is to remove foreign matters such as contaminants in the curable composition. The method of filtration is not particularly limited, and a method in which pressure filtration is carried out by using a membrane-type filter, cartridge-type filter or the like, is preferred, wherein the filters have a pressure filtration pore size of 1.0 μm.

The curable composition of the present invention, which is produced, for example, as described above, is cured and the resulting cured material can be preferably used as an optical material for optical lenses, optical disk substrates, plastic substrates for liquid crystal display elements, substrates for color filters, substrates for organic EL display elements, substrates for solar cells, touch panels, optical elements, sealing media for optical waveguide and LED, etc.

### [Cured Material]

### <Manufacturing Process of a Cured Material>

A cured material is obtainable by curing the curable composition of the present invention. Examples of the method for curing include a method in which ethylenically unsaturated groups are cross-linked each other by irradiation with active energy rays, a method in which ethylenically unsaturated groups are thermally polymerized by heating, and the like; and combinations of them can be used.

In cases where the curable composition is cured by active energy rays such as ultraviolet rays, the curable composition contains a photoinitiator(s) at the above-described step 4.

In cases where the curable composition is cured by heating, the curable composition contains a thermal polymerization initiator(s) at the above-described step 4.

The cured material of the present invention can be obtained by applying the curable composition of the present invention on a substrate such as glass plate, plastic plate, metal plate or silicon wafer to form a coating film, followed by irradiation with active energy rays to the curable composition or by heating the curable composition. Both irradiating active energy rays and heating may be carried out for curing.

Examples of the method for applying the curable composition include, for example, application using a bar coater, applicator, die coater, spin coater, spray coater, curtain coater or roll coater and the like, and application by screen printing and the like, application by dipping and the like.

The amount of the curable composition of the present invention to be applied on a substrate is not particularly limited, and it can be appropriately adjusted depending on the purpose. The amount of the curable composition is preferably an amount to give a coating film having a film thickness from 1 to 1,000 μm, and more preferably an amount to give a coating film having a film thickness from 10 to 800 μm, after a curing treatment by irradiation with active energy rays and/or by heating.

As active energy rays used for curing, the electron beam or the light within a wavelength range from electron rays or ultraviolet rays to infrared rays is preferred.

As a light source, for example, an extra-high pressure mercury light source or metal halide light source for ultraviolet rays, a metal halide light source or halogen light source for visible rays, and a halogen light source for infrared rays can be used, and light sources such as laser and LED can be used other than those.

The dose of active energy rays is appropriately set depending on the kind of a light source, the film thickness of a coating film, and the like, and can be appropriately set such that the reaction rate of the ethylenically unsaturated groups in the reactive (meth)acrylate(s) (b) and the reactive (meth)allyl(s) (c) will be preferably not less than 80%, and more preferably not less than 90%. The reaction rate is calculated from the infrared absorption spectra, from the change in intensity at the absorption peak for the ethylenically unsaturated groups between before and after the reaction.

Furthermore, the curing can be progressed further by a heating treatment (annealing treatment) after curing by irradiation with active energy rays. The heating temperature during the treatment is preferably within a range from 80 to 220° C. The heating time is preferably within a range from 10 to 60 min.

In cases where the curable composition of the present invention is thermally polymerized by a heating treatment for curing, the heating temperature is preferably within a range from 80 to 200° C. and more preferably within a range from 100 to 150° C.

When the heating temperature is lower than 80° C., heating time is needed to be prolonged and it tends to result in uneconomical production; when the heating temperature is higher than 200° C., it has a high energy cost and takes more heating-up time and more temperature-falling time and therefore it tends to result in uneconomical production.

The heating time is appropriately set depending on the heating temperature, the film thickness of a coating film, and the like, and can be appropriately set such that the reaction rate of the ethylenically unsaturated groups in the reactive (meth)acrylate(s) (b) and the reactive (meth)allyl(s) (c) will be preferably not less than 80%, and more preferably not less than 90%. The reaction rate is calculated as described above from the infrared absorption spectra, from the change in intensity at the absorption peak for the ethylenically unsaturated groups between before and after the reaction.

### <Cured Material>

The reactive (meth)acrylate(s) (b) and the reactive (meth)allyl(s) (c) are rigidly cured in the cured material of the present invention so that the cured material has excellent thermal durability and surface hardness and also has a transparency equal to or higher than those of conventional products. Accordingly, the cured material can be preferably used as an optical material for optical lenses, plastic substrates for liquid crystal display elements, substrates for color filters, plastic substrates for organic EL display elements, substrates for solar cells, touch panels, optical elements, sealing media for optical waveguide and LED, etc.

The cured material of the present invention has a small Abbe number because the curable composition contains the (meth)allyl(s) (c), and the Abbe number of the cured material is typically not more than 50 and preferably not more than 45. Therefore, an optical material with a small chromatic aberration can be obtained by combining the cured material of the present invention and a material(s) with a large Abbe number, for example, poly (methyl methacrylate) resins and cycloolefin polymer resins. Additionally, the Abbe number of the cured material is calculated from the refractive indexes at 486 nm, 589 nm and 656 nm in wavelength, which have been measured at 30° C. In the cured material of the present invention, the Abbe number is typically 20 or more.

The cured material of the present invention is excellent in thermal durability. In particular, because the cured material of the present invention is obtainable by curing the curable composition, which preferably contains the reactive (meth)acrylate(s) (b) and the reactive (meth)allyl(s) (c), wherein each of their homopolymers has a high glass transition temperature, the obtained cured material is highly excellent in thermal durability. Therefore, when the cured material is heated under nitrogen atmosphere, the 5% weight loss temperature thereof is typically not less than 300° C., preferably not less than 320° C., and more preferably not less than 340° C. When the 5% weight loss temperature during heating is less than 300° C., in cases where this cured material is used, for example, as a substrate for active matrix display devices, problems such as bending and deflection and optionally cracking can occur in the manufacturing process thereof.

In the cured material of the present invention, in cases where the thickness of a cured film is 300 μm, the light transmittance at a wavelength of 400 nm is not less than 80%, and therefore the cured material is excellent in transparency. In cases where the light transmittance at a wavelength of 400 nm is less than 80%, the efficiency in using light is decreased, and therefore the cured material is not suitable for applications, in which light efficiency is important.

Moreover, in the cured material of the present invention, in cases where the thickness of a cured film is 300 μm, the total light transmittance is not less than 90%, and therefore the cured material is excellent in transparency. In cases where the total light transmittance is less than 90%, the efficiency in using light is decreased, and therefore the cured material is not suitable for applications, in which light efficiency is important.

In the cured material of the present invention, the absolute value of the temperature-dependent coefficient of refractive index is about 10.0×10⁻⁵/° C. or less, and it is almost the same as or less than 10.7×10⁻⁵/° C., the absolute value of the temperature-dependent coefficient of refractive index of a polycarbonate which is a conventionally used material for optical lenses and the like, and therefore the cured material is excellent in environmental durability.

Additionally, the temperature-dependent coefficient of refractive index means a slope of a line obtained by plotting refractive indexes at a wavelength of 594 nm against temperature, wherein the refractive indexes are measured using a Model 2010M Prism Coupler (manufactured by Metricon Corporation) at a measurement temperature varying from 30 to 60° C. in 5-degree intervals.

Since the cured material of the present invention is excellent in all of transparency, thermal durability and surface hardness, and has a small Abbe number as described above, an optical material having excellent properties such as transparency and having a reduced chromatic aberration can be obtained by combining the cured material with a material(s) with a large Abbe number, specifically, by producing an optical unit, into which the material(s) with a large Abbe number and the material with a small Abbe number are unified with a holder and the like.

### EXAMPLES

Hereinafter, the present invention will be described in more detail with Examples and Comparative Examples, and the present invention shall not be limited in any way by these descriptions.

### <Preparation of a Curable Composition>

### Example 1

### Curable Composition (A-1)

To a separable flask, 100 parts by mass of a colloidal silica dispersed in isopropyl alcohol (silica content: 30% by mass, average particle diameter: 10 to 20 nm, Trade Name: Snowteck IPA-ST, manufactured by Nissan Chemical Industries, Ltd.) were added; to the separable flask, 6.0 parts by mass of γ-methacryloxypropyl trimethoxysilane and 9.0 parts by mass of phenyltrimethoxysilane were added and mixed by stirring, and 4.8 parts by mass of hydrochloric acid having a concentration of 0.1825% by mass were further added and the mixture was stirred at 20° C. for 24 hours; and thus the surface treatment of the silica fine particles was carried out.

The losses of γ-methacryloxypropyltrimethoxysilane and phenyltrimethoxysilane due to hydrolysis were confirmed by gas chromatography (Model 6850; manufactured by Agilent Technologies Inc.). The measurement using the internal standard method was carried out using a non-polar column DB-1 (manufactured by J&W Scientific) at a temperature from 50 to 300° C. at a heating rate of 10° C./min and using He as a carrier gas at a flow rate of 1.2 cc/min and using a hydrogen flame ionization detector. γ-methacryloxypropyltrimethoxysilane and phenyltrimethoxysilane were diminished 8 hours after addition of the above-described hydrochloric acid.

Next, 45 parts by mass of trimethylolpropane triacrylate (Trade Name: KAYARAD, Abbreviation: TMPTA, manufactured by NIPPON KAYAKU Co., Ltd., Tg of the homopolymer: >250° C.), 12 parts by mass of naphthalenedicarboxylic acid diallyl ester (Trade Name: DAND, manufactured by Nihon Jyoryu Kogyo Co. Ltd), 12 parts by mass of 9,9-bis[4-(2-acryloyloxyethoxy)phenyl]fluorene (Trade Name: A-BPEF, manufactured by Shin-Nakamura Chemical Co., Ltd.) and 25 parts by mass of EA-F5503 (manufactured by Osaka Gas Chemicals Co., Ltd., Tg of the homopolymer: 115° C.) were added to the surface-treated silica fine particles and they were mixed uniformly. Then volatile components were removed by heating at 40° C. with stirring under a reduced pressure of 100 kPa.

In 100 parts by mass of the obtained mother liquid, 0.15 parts by mass of pentamethylpiperidinyl methacrylate (Trade Name: FA-711MM, manufactured by Hitachi Chemical Co., Ltd.), 0.15 parts by mass of isooctyl-3-(3,5-di-t-butyl-4-hydroxyphenyl)propionate (Trade Nambe: IRGANOX 1135, manufactured by BASF Japan Ltd.) and 1 part by mass of t-butylperoxy-2-ethylhexanoate (Trade Name: PERBUTYL O, manufactured by NOF Corporation) as a thermal polymerization initiator were dissolved to give the curable composition (A-1).

### Example 2

### Curable Composition (A-2)

The curable composition (A-2) was obtained in the same operation as in Example 1, except that, in Example 1, the used amounts of DAND, A-BPEF and EA-F5503 were changed to 10 parts by mass, 21 parts by mass and 19 parts by mass, respectively.

### Example 3

### Curable Composition (A-3)

The curable composition (A-3) was obtained in the same operation as in Example 1, except that, in Example 1, the used amounts of DAND and A-BPEF were changed to 11 parts by mass and 21 parts by mass, respectively, and EA-F5503 was not used.

### Example 4

### Curable Composition (A-4)

The curable composition (A-4) was obtained in the same operation as in Example 1, except that, in Example 1, 6 parts by mass, 13 parts by mass and 31 parts by mass of DAND, A-BPEF and EA-F5503, respectively, were used.

### Example 5

### Curable Composition (A-5)

The curable composition (A-5) was obtained in the same operation as in Example 1, except that, in Example 1, 11 parts by mass of diallyl diphenate (Trade Name: DAD, manufactured by Nihon Jyoryu Kogyo Co. Ltd) were used in place of DAND, the used amount of EA-F5503 was changed to 21 parts by mass, and A-BPEF was not used.

### Example 6

### Curable Composition (A-6)

The curable composition (A-6) was obtained in the same operation as in Example 1, except that, in Example 1, the used amounts of TMPTA and DAND were changed to 26 parts by mass and 19 parts by mass, respectively, and A-BPEF and EA-F5503 were not used.

### Comparative Example 1

### Curable Composition (B-1)

The curable composition (B-1) was obtained in the same operation as in Example 1, except that, in Example 1, the used amount of TMPTA was changed to 23 parts by mass, 23 parts by mass of adamantyl methacrylate (Trade Name: ADMA, manufactured by Osaka Organic Chemical Industry, Ltd., Tg of the homopolymer: 180° C.) were used, and A-BPEF, EA-F5503 and DAND were not used.

### Comparative Example 2

### Curable Composition (B-2)

The curable composition (B-2) was obtained by mixing and dissolving 40 parts by mass of TMPTA, 15 parts by mass of DAND, 15 parts by mass of A-BPEF, 30 parts by mass of EA-F5503, 0.15 parts by mass of pentamethylpiperidinyl methacrylate, 0.15 parts by mass of IRGANOX 1135 and 1 part by mass of PERBUTYL 0 as a thermal polymerization initiator.

### Comparative Example 3

A polycarbonate resin (manufactured by Paltec Test Panels, Co., Ltd.) was used, which is commonly used as an optical material and is commercially available.

### <Production of a Cured Film>

Each of the curable compositions (A-1) to (A-6) and (B-1) to (B-2) prepared in Examples 1 through 6 and Comparative Examples 1 and 2 described above was applied on separate glass substrates such that the thickness of a cured film would be 300 μm, and was subjected to a heating treatment at 130° C. for 30 min to cure the coating film. Then, an annealing treatment at 180° C. for 30 min was performed.

### <Methods of Property Evaluation>

### (1) Refractive Index

The refractive index at a wavelength of 594 nm was measured for each cured film before the annealing treatment obtained in the above-described <Production of a cured film> by using a Model 2010M Prism Coupler (manufactured by Metricon Corporation) at 30° C. The results are shown Tables 1 and 2.

### (2) Abbe Number

The Abbe number of each cured film before the annealing treatment obtained in the above-described <Production of a cured film> was calculated from the refractive indexes of the cured film at 486 nm, 589 nm and 656 nm in wavelength, which were measured using a Model 2010M Prism Coupler (manufactured by Metricon Corporation) at 30° C. The results are shown Tables 1 and 2. In case of considering the combination with a material(s) with a large Abbe number, a more excellent cured film has a smaller Abbe number.

### (3) Temperature-Dependent Coefficient of Refractive Index

The refractive index was measured for each cured film before the annealing treatment obtained in the above-described <Production of a cured film> by using a Model 2010M Prism Coupler (manufactured by Metricon Corporation) at a measurement temperature varying from 30 to 60° C. in 5-degree intervals, and the refractive indexes at a wavelength of 594 nm were plotted against temperature to give a line, and thus the absolute value of the slope of the line was obtained as a temperature-dependent coefficient of refractive index. The results are shown Tables 1 and 2. A lower value means the smaller temperature dependence of refractive index and the more excellent environmental durability.

### (4) Visible and Ultraviolet Light Transmittance

The light transmittance (T %) at 400 nm of each cured film before the annealing treatment obtained in the above-described <Production of a cured film> was measured using a spectrophotometer (UV 3600 manufactured by JASCO Corporation) in accordance with JIS-K7105. The results are shown Tables 1 and 2. A more excellent cured film has a higher value of the transmittance.

### (5) Total Light Transmittance

The total light transmittance of each cured film before the annealing treatment obtained in the above-described <Production of a cured film> was measured using a haze meter COH400 (manufactured by Nippon Denshoku Industries Co., Ltd.). The results are shown Tables 1 and 2. A more excellent cured film has a higher value of the transmittance.

### (6) 5% Weight Loss Temperature

For each cured film before the annealing treatment obtained in the above-described <Production of a cured film>, the 5% weight loss temperature thereof was measured using a TG-DTA (manufactured by Seiko Instruments & Electronics Ltd.), while heating it within a temperature range of 20 to 500° C. at a heating rate of 10° C./min under nitrogen atmosphere. The results are shown in Tables 1 and 2. A thermally more durable cured film has a higher value of 5% weight loss temperature thereof.

### (7) Bending

For each cured film obtained in the above-described <Production of a cured film>, the occurrence of bending after an annealing treatment at 180° C. for 30 min was confirmed visually.

The evaluation criterion is as shown below, and the results are shown in Tables 1 and 2. Additionally, in cases where there was produced a gap of 1 mm or more between the periphery of a cured film and a flat plane when the cured film was placed on the flat plane, the cured film was determined to have a bend.

o: Bending hardly occurs.

x: Bending always occurs, or a cured film melts.

### (8) Pencil Hardness

Each cured film before the annealing treatment obtained in the above-described <Production of a cured film> was scratched with surface property tester (manufactured by Shinto Scientific Co., Ltd.) and UNI® pencils manufactured by Mitsubishi Pencil Co., Ltd. in such a manner that the angle between a pencil and a cured film was 45 degree; the most hard pencil was determined among those which made no scratch mark in accordance with JIS-K5600; and the hardness of the pencil was considered as the pencil hardness of the cured film. The results are shown in Tables 1 and 2.

TABLE 1

| Evaluation criteria | unit | Example 1 | Example 2 | Example 3 | Example 4 | Example 5 | Example 6 |
|---|---|---|---|---|---|---|---|
| Refractive index | . . . | 1.55077 | 1.54741 | 1.54055 | 1.54828 | 1.53402 | 1.51131 |
| Abbe number | . . . | 34.4 | 35.7 | 35.8 | 34.5 | 38.7 | 39.8 |
| Temperature | ×10⁻⁵/° C. | 8.37 | 9.60 | 10.5 | 10.4 | 10.9 | 8.05 |
| dependent | | | | | | | |
| coefficient of | | | | | | | |
| refractive index | | | | | | | |
| Light transmittance | % | 84.6 | 84.5 | 86.5 | 84.9 | 88.7 | 86.0 |
| Total light | % | 91.2 | 91.4 | 91.6 | 91.4 | 91.9 | 92.1 |
| transmittance | | | | | | | |
| Temperature of | ° C. | 315 | 359 | 348 | 351 | 354 | 347 |
| weight loss | | | | | | | |
| Bending | . . . | ∘ | ∘ | ∘ | ∘ | ∘ | ∘ |
| Pencil hardness | . . . | 4H | 3H | 3H | 3H | 4H | 4H |

TABLE 2

| Evaluation | | Comparative | Comparative | Comparative |
|---|---|---|---|---|
| criteria | unit | Example 1 | Example 2 | Example 3 |
| Refractive | . . . | 1.49920 | 1.57347 | 1.5841 |
| index | | | | |
| Abbe number | . . . | 53.5 | 31.7 | 30.0 |
| Temperature | x | 6.81 | 13.0 | 10.7 |
| dependent | 10⁻⁵/° C. | | | |
| coefficient of | | | | |
| refractive | | | | |
| index | | | | |
| Light | % | 91.4 | 87.7 | 89.0 |
| transmittance | | | | |
| Total light | % | 92.8 | 91.4 | 92.0 |
| transmittance | | | | |
| Temperature of | ° C. | 355 | 353 | 473 |
| weight loss | | | | |
| Bending | . . . | ∘ | x | x |
| Pencil | . . . | 5 H | 4 H | B |
| hardness | | | | |

Table 1 indicates that each of the cured materials obtainable by curing the curable compositions shown in Examples 1 through 6 has a small Abbe number.

The temperature-dependent coefficients of refractive index of the cured materials obtainable by curing the curable compositions of the present invention are equal to or higher than that of the polycarbonate resin shown in Comparative Example 3 of Table 2 (the numerical values thereof are equal to or lower than that of the polycarbonate), which polycarbonate is commonly used as an optical material. The cured material obtainable by curing the curable composition shown in Comparative Example 1 of Table 2 has excellent transparency, thermal durability and environmental durability; but it has a large Abbe number and therefore has a small effect on reduction in chromatic aberration. The cured material shown in Comparative Example 2 has a sufficiently small Abbe number; but it has a high temperature-dependent coefficient of refractive index and therefore has poor environmental durability. Furthermore, bending always occurs after the annealing treatment in the cured material and therefore it is difficult to utilize the cured material as an optical material. The polycarbonate resin shown in Comparative Example 3 also has a sufficiently small Abbe number, but it has poor thermal durability, and therefore it melts at the temperature for the annealing treatment. Moreover, the pencil hardness thereof is low and the surface hardness thereof is poor, and therefore, in cases where it is used as an optical material, a scratch can be formed on the surface thereof.

Each of the cured materials obtainable by curing the curable compositions of the present invention has a light transmittance (400 nm) not less than 80% and also a total light transmittance not less than 90%, and therefore it is excellent in transparency; and it has sufficient thermal durability and surface hardness, and has a small Abbe numbers.

### INDUSTRIAL APPLICABILITY

A cured materials obtainable by curing the curable composition of the present invention, which is composed of the silica fine particles subjected to a surface treatment with the specified two kinds of silane compounds, the specified (meth)acrylate compound(s), the specified (meth)allyl compound(s), and the polymerization initiator(s), has excellent transparency and thermal durability and has a small Abbe number, and the combination of the cured materials with a material(s) with a large Abbe number can reduce effectively the chromatic aberration.

The cured material can be preferably used for transparent plates, optical lenses, optical disk substrates, plastic substrates for liquid crystal display elements, substrates for color filters, plastic substrates for organic EL display elements, substrates for solar cells, touch panels, optical elements, sealing media for optical waveguide and LED, and the like.

1. A curable composition comprising:
(a) silica fine particles;
(b) a (meth)acrylate compound having two or more ethylenically unsaturated groups;
(c) a (meth)allyl compound having two or more ethylenically unsaturated groups and having an aromatic ring structure; and
(d) a polymerization initiator;
wherein the surface of the silica fine particles (a) is treated with a silane compound (e) represented by the general formula (1) below and a silane compound (f) represented by the general formula (2) below: 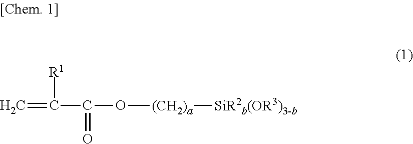
(wherein in formula (1), R¹ represents a hydrogen atom or a methyl group; R² represents an alkyl group having 1 to 3 carbon atoms or a phenyl group; R³ represents a hydrogen atom or a hydrocarbon group having 1 to 10 carbon atoms; a is an integer of 1 to 6; b is an integer of 0 to 2; when b is 0 or 1, the plural R³s may be the same or different; and when b is 2, the two R²s may be the same or different);
[Chem. 2]
X—(CH₂)_{c}—SiR⁴_{d}(OR⁵)_{3-d} (2)
(wherein in formula (2), X represents an aromatic group having 6 to 12 carbon atoms; R⁴ represents an alkyl group having 1 to 3 carbon atoms or a phenyl group; R⁵ represents a hydrogen atom or a hydrocarbon group having 1 to 12 carbon atoms; c is an integer of 0 to 6; d is an integer of 0 to 2; when d is 0 or 1, the plural R⁵s may be the same or different; and when d is 2, the two R⁴s may be the same or different).

2. The curable composition according to claim 1, wherein the (meth)allyl compound (c) is represented by the general formula (3) below: 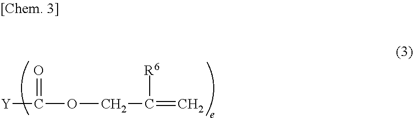
(wherein in formula (3), e is an integer of 2 to 4; R⁶ represents a hydrogen atom or a methyl group; the plural R⁶s may be the same or different; and Y represents an organic residue having 6 to 18 carbon atoms and having an aromatic ring structure).

3. The curable composition according to claim 1, wherein in the general formula (1) R¹ represents a methyl group; R² represents a methyl group; R³ represents a methyl group or an ethyl group; a is 2 or 3; and b is 0 or 1.

4. The curable composition according to claim 1, wherein in the general formula (2) X represents a phenyl group, R⁴ represents a methyl group; R⁵ represents a methyl group or an ethyl group; c is 0 or 1; and d is 0 or 1.

5. The curable composition according to claim 1, wherein the (meth)acrylate compound (b) is a (meth)acrylate compound having three or more ethylenically unsaturated groups and having no ring structure.

6. The curable composition according to claim 1, wherein the (meth)acrylate compound (b) is a (meth)acrylate compound having two ethylenically unsaturated groups and having a fluorene structure.

7. The curable composition according to claim 1, wherein the surface of the silica fine particles (a) is treated with 5 to 95 parts by mass of the silane compound (e) per 100 parts by mass of the silica fine particles (a) and with 5 to 95 parts by mass of the silane compound (f) per 100 parts by mass of the silica fine particles (a).

8. The curable composition according to claim 1, wherein a homopolymer of the (meth)acrylate compound (b) has(have) a glass transition temperature not less than 80° C.

9. The curable composition according to claim 1, comprising 5 to 200 parts by mass of the (meth)allyl compound (c) per 100 parts by mass of the silica fine particles (a), whose surface has not been treated.

10. The curable composition according to claim 1, comprising 20 to 500 parts by mass of the (meth)acrylate compound (b) per 100 parts by mass of the silica fine particles (a), whose surface has not been treated.

11. The curable composition according to claim 1, comprising 0.01 to 10% by mass of the polymerization initiator (d) per 100% by mass of the curable composition.

12. A cured material obtainable by curing the curable composition according to claim 1.

13. The cured material according to claim 12, wherein the Abbe number of the cured material is not more than 50.

14. An optical material composed of the cured material according to claim 12.

15. An optical lens composed of the cured material according to claim 12.

16. The curable composition according to claim 2, wherein in the general formula (1) R¹ represents a methyl group; R² represents a methyl group; R³ represents a methyl group or an ethyl group; a is 2 or 3; and b is 0 or 1.

17. An optical material composed of the cured material according to claim 13.

18. An optical lens composed of the cured material according to claim 13.
